(19) United States
(12) Patent Application Publication
(10) Pub. No.: US 2012/0257109 A1
(43) Pub. Date: Oct. 11, 2012

(54) APPARATUS, SYSTEM AND METHOD FOR PROVIDING TOUCH INPUTS

(75) Inventor: Vrushali Vasant SHINDE, Karad (IN)

(73) Assignee: SAMSUNG ELECTRONICS CO. LTD., Suwon-si (KR)

(21) Appl. No.: 13/439,467

(22) Filed: Apr. 4, 2012

(30) Foreign Application Priority Data
Apr. 11, 2011 (IN) 1249/CHE/2011
Sep. 28, 2011 (KR) 10-2011-0097885

(51) Int. Cl. G06F 3/041; H04N 5/445

(52) U.S. Cl. 348/563; 348/E05.099

(57) ABSTRACT

An apparatus, system and method for providing touch inputs to a display device are disclosed. The apparatus includes: a touch screen display which receives a touch input from a user; a communication unit which communicates with the display device; and a controller which controls the touch screen display to display a first sub video corresponding to at least one area of first main video being currently displayed on the display device, controls the touch screen display to receive a first user touch input about the first sub video, and controls the communication unit to receive, from the display device, a second sub video corresponding to a position of the first sub video in a second main video corresponding to the first user touch input.

### CROSS-REFERENCE TO RELATED APPLICATION

This application claims priority from Indian Patent Application No. 1249/CHE/2011, filed on Apr. 11, 2011 in the Office of the Controller General of Patent, Designs & Trademarks of India, and claims priority from Korean Patent Application No. 10-2011-0097885, filed on Sep. 28, 2011 in the Korean Intellectual Property Office, the disclosures of which are incorporated herein by reference in their entireties.

### BACKGROUND

1. Field

Apparatuses and methods consistent with the exemplary embodiments relate to user interface systems, and more particularly to a method and system for providing touch inputs to display devices.

2. Description of the Related Art

A touch screen display device is primarily used as an input device and an output device. A touch screen display device enables a user to interact with an application. The touch screen display device enables interaction with the application directly rather than indirectly, for example, by using a mouse or a cursor. Examples of application include, but are not limited to, a plurality of games, video, audio, calculator, calendar and navigation. Inputs to the touch screen display device can be imparted by the user using a finger. Further, passive devices, for example, a stylus can also be used by the user to provide inputs to the touch screen display device.

Typically, a touch screen display device is embedded in an electronic device. Examples of electronic devices include, but are not limited to, desktop, laptop, hand held computers, cell phones, personal digital assistant (PDA), smart phones, digital television (DTV), internet protocol television (IPTV), and play stations. Conventionally, a touch screen display device associated with an electronic device requires the user to disassemble the touch screen display device and further reassemble the touch screen display device in order to install a touch screen unit. A touch screen unit can be regarded as a device that enables the user to provide touch inputs. A touch screen unit includes an area for providing touch inputs to the touch screen display device. Touch inputs enables the user to provide input to the touch screen display device in the form of touch with a finger. Further, touch inputs can also be provided using passive devices, for example, a stylus. A touch unit associated with an electronic device converts a non-touch screen electronic device into a touch screen display device. However, installation of the touch unit for conversion results in incurring additional time and money by the user. Hence, the complexity involved in installing a touch unit is undesirable.

FIG. 1 is a block diagram of a system 100 for providing touch inputs. The touch screen display unit 100 includes a casing 110. A touch screen 120 is integrated into the casing 110. The casing 110 along with the touch screen 120 is mounted on a display 140 of an electronic device. The electronic device can be connected to the touch screen 120 using a universal serial bus (USB) 130. The inputs imparted to the touch screen 120 are transmitted to the electronic device using the USB 130 thereby, converting a non-touch screen display unit into a touch screen display unit. However, the touch screen display unit cannot be accessed remotely. Further, the touch screen display unit is unable to affirm multiple touch sensitivities to the touch screen display unit.

FIG. 2 is a block diagram of another system 200 for providing touch inputs. The system 200 includes a touch pad 205. Button devices 215a and 215b are integrated into the touch pad 205. Further, a pointer device 210 is also integrated into the touch pad 205. The button device-1 as shown in 215a allows a user to select an application from a plurality of applications present on an electronic device. Further, the button device-2 as shown in 215b allows the user to perform a plurality of functions associated with the application. Examples of various functions include, but are not limited to, cut, copy, paste, display and format. Furthermore, the pointer device 210 allows the user to move a cursor associated with the electronic device. However, the system 200 does not enable the user to provide touch inputs because the positioning of the application in an electronic device producing a main display device is not connected to the system 200.

In the light of the foregoing discussion there is a need for an efficient method and system for providing touch inputs to a display device that addresses the above mentioned problems.

### SUMMARY

One or more exemplary embodiments may provide an apparatus, system and method for providing touch inputs to a display device that cannot receive a user's touch inputs.

According to an aspect of an exemplary embodiment, a system for providing touch inputs to a display device includes a personal display device for providing touch inputs and a server. The server is configured to receive an area of a main display video associated with an application using a transmission channel, to transmit the area of the main display video associated with application to a personal display device using the transmission channel, to receive a touch input from the personal display device, and to transmit at least one of the touch input and the area of the main display video associated with application to an electronic device.

The server may be interconnected to one or more personal display devices through a network using one or more network interfaces.

The personal display device may include a display unit.

The touch input may include a portion of an area associated with the main display video.

The personal display device may include a selection panel.

The personal display device may include a pointing device.

One or more personal display devices may be interconnected to one or more electronic devices using the server.

One or more personal display devices may be interconnected to one or more electronic devices producing the main display video through a network.

One or more personal display devices may be configured to display the area of the main display video associated with the application through the network.

According to an aspect of another exemplary embodiment a method for providing touch inputs to a display device includes the operation of transmitting an area of a main display video associated with an application by an electronic device to a server. The method also includes the operation of transmitting the area of the main display video associated with application to a personal display device by the server using a transmission channel. Further, the method includes the operation of selecting an area of the main display video associated with the application to be displayed by the personal display device. The method further includes the operation of performing a scaling operation by the personal display device. Moreover the method further includes the operation of displaying the area of the main display video associated with application by the personal display device. The method also includes the operation of providing a touch input to the application by the personal display device. The method further includes the operation of mapping the touch input associated with the application by the personal display device. Further, the method includes the operation of transmitting the touch input and the application to the server by the personal display device. Moreover, the method includes the operation of transmitting the touch input to the electronic device associated with the main display video by the server.

The electronic device producing the main display video may include one of a consumer electronic device (CE), an internet protocol television (IPTV) and a digital television (DTV).

The application may be embedded in the electronic device producing the main display video.

The personal display device may include a display unit.

The calculating the scaling operation may include computing a portion of an area associated with the main display video.

The computing the portion of an area associated with the main display video may be performed using a selection panel and a pointing device.

The portion of an area associated with the main display video may be altered dynamically.

The portion of an area associated with the main display video may include an area of the personal display device for imparting the touch input.

The portion of an area associated with the main display video may include a sensitivity associated with the touch input.

The sensitivity associated with the touch input may be varied by varying the portion of an area associated with the main display video.

The touch input may be provided by one of a stylus and a finger touch.

The mapping may include associating the touch inputs with the area of the main display video associated with the application.

The method may further include: performing scribbling function on the personal display device.

The scribbling may be displayed on one or more electronic devices producing the main display video.

According to an aspect of another exemplary embodiment, an apparatus for providing touch inputs to a display device that cannot receive a user's touch inputs includes: a touch screen display which receives a touch input from a user; a communication unit which communicates with the display device; and a controller which controls the touch screen to display a first sub video corresponding to at least one area of first main video being currently displayed on the display device, controls the touch screen display to receive a first user touch input about the first sub video, and controls the communication unit to receive, from the display device, second sub video corresponding to a position of the first sub video in a second main video being displayed on the display device corresponding to the first user touch input.

The controller may convert the first user touch input about the first sub video into a second user touch input about the first main video and controls the communication unit to transmit the second user touch input to the display device.

The apparatus may further include a user input unit which receives a user input for selecting the first sub video in the first main video.

The apparatus may further include a signal processor which processes the first sub video and the second sub video to be displayed on the touch screen display.

According to an aspect of another exemplary embodiment a system for providing touch inputs includes: a display device that cannot receive a user's touch inputs; and a first touch input provider including: a touch screen display which receives a touch input from a user, a communication unit which communicates with the display device, and a controller which controls the touch screen display to display a first sub video corresponding to at least one area of first main video being currently displayed on the display device, controls the touch screen display to receive a first user touch input about the first sub video, and controls the communication unit to receive, from the display device, a second sub video corresponding to a position of the first sub video in a second main video corresponding to the first user touch input.

The controller may convert the first user touch input about the first sub video into a second user touch input about the first main video and control the communication unit to transmit the second user touch input to the display device.

The system may further include a user input unit which receives a user input for selecting the first sub video in the first main video.

The system may further include a signal processor which processes the first sub video and the second sub video to be displayed on the touch screen display.

The system may further include a second touch input provider which communicates with the display device, where the second touch input provider includes a second touch screen which receives a touch input from a user, a second communication unit which communicates with the display device, and a second controller which controls the second touch screen display to display a third sub video corresponding to at least one area of the first main video, controls the second touch screen display to receive a third user touch input about the third sub video, and controls the second communication unit to receive, from the display device, a fourth sub video corresponding to a position of the third sub video in a third main video corresponding to the third user touch input.

The first sub video and the third sub video may be different from each other.

According to an aspect of another exemplary embodiment a method of providing touch inputs in a touch input provider which provides touch inputs to a display device that cannot receive a user's touch inputs includes: displaying first sub video on a touch screen display of the touch input provider, wherein the first sub video corresponds to at least one area of first main video being currently displayed on the display device, on a touch screen display; receiving a first user touch input about the first sub video through the touch screen display; transmitting the first user touch input to the display device through a communication unit; and receiving a second sub video corresponding to a position of the first sub video in a second main video being displayed on the display device, the second sub-video corresponding to the first user touch input from the display device and displaying the second sub video on the touch screen display.

The transmitting the first user touch input may include converting the first user touch input about the first sub video into a second user touch input about the first main video and transmitting the second user touch input to the display device.

The method may further include selecting the first sub video in the first main video through a user input unit.

The method according to claim 11, further including processing the first sub video and the second sub video to be displayed on the touch screen display.

According to an aspect of another exemplary embodiment a method of providing touch inputs in a touch input provider of a system including a display device that cannot receive a user's touch inputs includes: displaying a first sub video on a touch screen display of the touch input provider, wherein the first sub video corresponds to at least one area of first main video being currently displayed on the display device; receiving a first user touch input about the first sub video, in the touch input provider; transmitting the first user touch input from the touch input provider to the display device; and receiving, from the display device, a second sub video corresponding to a position of the first sub video in a second main video being displayed on the display device, the second sub video corresponding to the first user touch input and displaying the second sub video in the touch input provider.

The transmitting the first user touch input may include converting the first user touch input about the first sub video into a second user touch input about the first main video and transmitting the second user touch input to the display device.

The method may further include selecting the first sub video in the first main video through the touch input provider.

The method may further include processing the first sub video and the second sub video to be displayed in the touch input provider.

The method may further include: displaying a third sub video on a second touch input provider, wherein the third sub video corresponds to at least one area in the first main video; receiving a third user touch input about the third sub video in the second touch input provider; and receiving a fourth sub video corresponding to a position of the third sub video in third main video, the fourth sub video corresponding to the third user touch input from the display device and displaying the fourth sub video in the second touch input provider.

The first sub video and the third sub video may be different from each other.

### BRIEF DESCRIPTION OF THE DRAWINGS

In the accompanying figures, similar reference numerals may refer to identical or functionally similar elements. Exemplary embodiment will be described with reference to the accompanying drawings, in which:

FIG. 1 is a block diagram of a system for providing touch inputs;

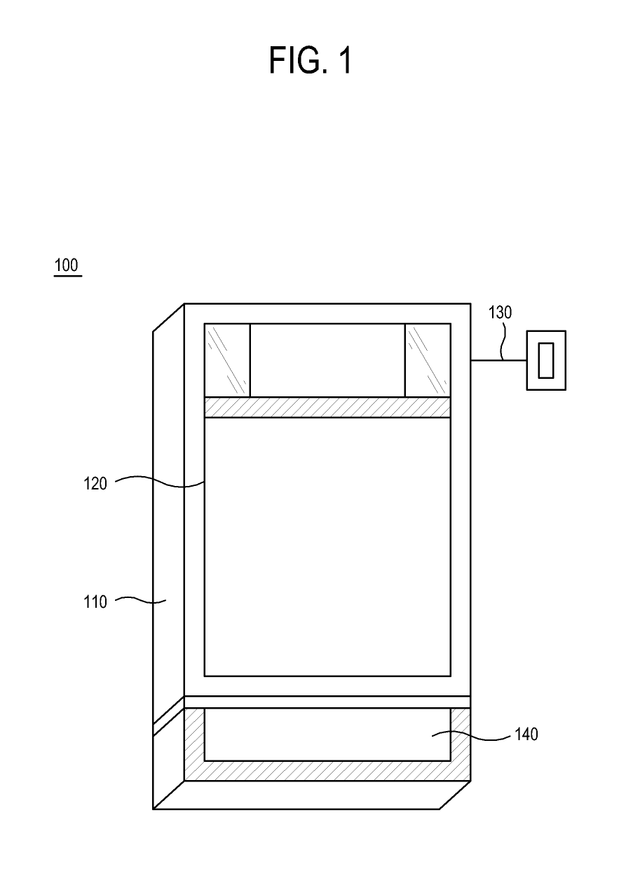

FIG. 2 is a block diagram of a system for providing touch inputs;

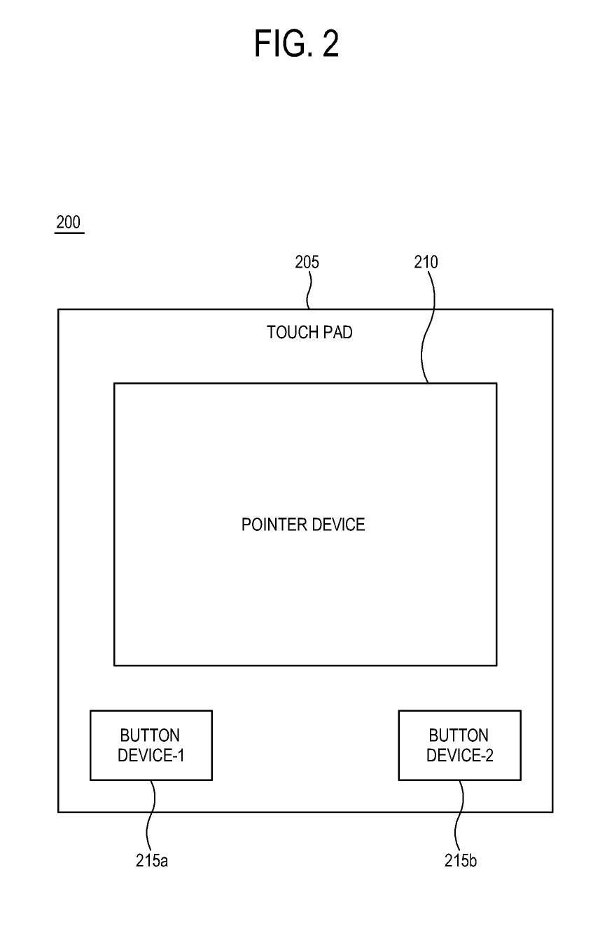

FIG. 3 is a block diagram of an environment, in accordance with which various exemplary embodiments can be implemented;

FIG. 4 is a flowchart illustrating a method for providing touch inputs to a display device in accordance with an exemplary embodiment;

FIG. 5 is a block diagram of a server in accordance with an exemplary embodiment;

FIG. 6 is an exemplary illustration associated with a first application for providing touch inputs in accordance with an exemplary embodiment;

FIG. 7 is an exemplary illustration associated with a second application for providing touch inputs in accordance with an exemplary embodiment;

FIG. 8 is an exemplary illustration for viewing contents displayed on the main display on multiple personal display devices in accordance with an exemplary embodiment;

FIG. 9 is a schematic view of a system for providing touch inputs according to another exemplary embodiment;

FIG. 10 is a control block diagram of a touch input provider according to another exemplary embodiment;

FIG. 11 is a flowchart of a control operation in the touch input provider in FIGS. 10; and

FIG. 12 is a flowchart of a control operation in the system for providing touch inputs in FIG. 9.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various exemplary embodiments.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

It should be observed that method operations and system components have been represented by conventional symbols in the figures, showing only specific details that are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities.

Exemplary embodiments described herein provide a method and system for providing touch inputs to a display device.

In recent years electronic device 305, for example, internet televisions and the like have been made available with a large number of built-in applications. Examples of built-in applications include, but are not limited to, calculator, calendar, games, internet browser, video, audio and video on demand (VOD). However, displays associated with internet televisions are large and hence providing touch screen facility to large displays is impracticable. Further utilizing small applications, for example, calculator, calendar and the like are unmanageable using large display associated with the electronic device 305. Therefore, one or more exemplary embodiments described herein provide a handy device capable of providing touch inputs to a large display associated with the internet television. The handy device can be regarded as a personal display device. Further, the personal display device can be remotely connected to the large displays associated with the electronic device 305.

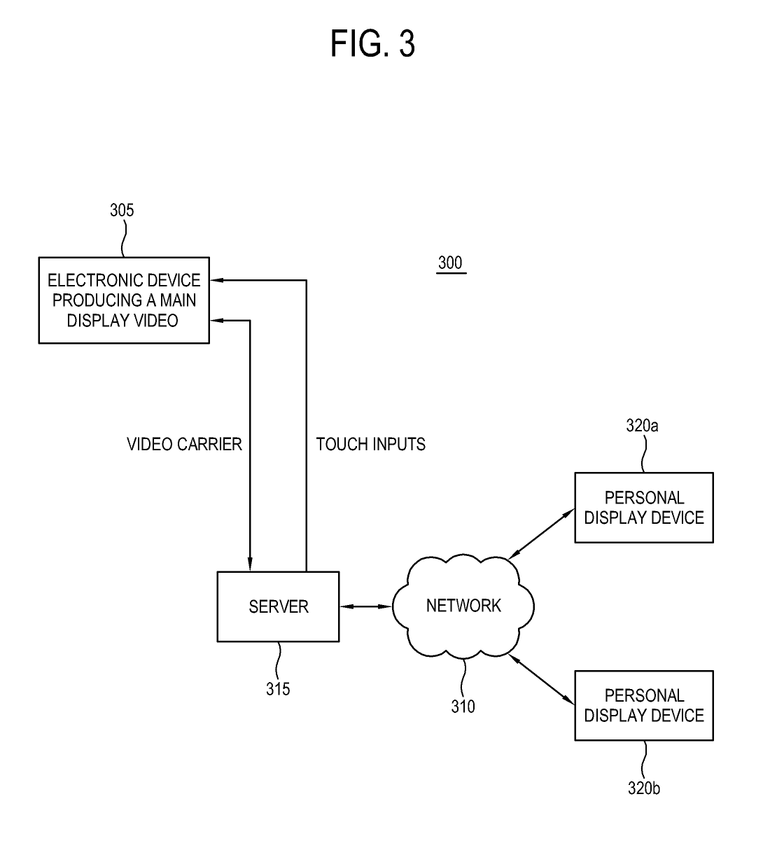

FIG. 3 is a block diagram of an environment 300, in accordance with which various exemplary embodiments can be implemented. The environment 300 includes an electronic device 305 producing a main display video, a network 310, a server 315 and personal display devices 320A and 320B.

A display device can be embedded in an electronic device 305 for displaying a main display video. Examples of electronic device 305 include, but are not limited to, desktop, laptop, hand held computers, cell phones, personal digital assistant (PDA), smart phones, digital television (DTV), internet protocol television (IPTV), and play stations. The electronic device 305 producing the main display video displays a plurality of applications. Examples of applications include, but are not limited to, a plurality of games, video, audio, calculator, calendar and navigation. Various forms of display devices can be embedded in the electronic device 305. Examples of various forms of main display devices include, but are not limited to, electronic visual display, electronic ink display, Liquid crystal display (LCD), cathode ray tube (CRT), light emitting diode (LED) display, plasma display and electroluminescent display.

The electronic device 305 producing the main display video enables a user to view the applications. The electronic device 305 producing the main display video can be a standalone display device. Further a plurality of electronic devices 305 can be interconnected to one another. Furthermore, the electronic device 305 producing the main display video can include a server associated within. One or more personal display devices can be connected to one or more or more servers that are associated with multiple electronic devices 305. The connection of one or more personal display devices to one or more or more servers enables the personal display devices to display a variety of display contents associated with multiple electronic devices 305 producing the corresponding main display videos simultaneously.

The electronic device 305 producing the main display video can be connected to the server 315. The electronic device 305 producing the main display video can be connected to the server 315 directly or through communication standards, for example universal serial bus (USB) and the like. The server 315 can be regarded as a software application that allows efficient exchange of data and touch inputs between the electronic device 305 producing the main display video and the personal display device. The data can include information associated with an application, video information and the like. The server 315 is configured to communicate with a plurality of electronic device s 305 producing the main display devices. Further, the server 315 is also configured to communicate with a plurality of personal display devices. The server transmits the touch inputs provided by the user using the personal display device to the electronic device 305 producing the main display video. Further, touch inputs provided by the user can be transmitted from the personal display device to the server through the network. Furthermore the server transmits the touch inputs provided by the user to the electronic device 305 producing the main display video through physical layer. The server restrains from utilizing the session layer to transmit touch inputs provided by the user to the electronic device 305 producing the main display video thereby avoiding transmission complexities.

Performance of the server depends on various parameters. Examples of various parameters include, but are not limited to, total number of personal display devices connected to the server. The personal display devices 320A and 320B are connected to the server 315 directly or through the network 310.

The electronic device 305 transmits data to the server 315 directly or through the network 310. Examples of the data include, but are not limited to analog VGA output, digital HDMI output, and graphics. The server can be connected to the personal display devices through the network 310. Examples of network include, but are not limited to, internet, Ethernet, local area network (LAN), wireless, wide area network (WAN), metropolitan area network (MAN), and small area network. In one example, the server 315 receives a request from the personal display device. The request includes the personal display device requesting for a portion of an area associated with the main display device to be displayed on the personal display device 320A. In response to the request, the server 315 sends the information corresponding to the portion of the area associated with the main display device to the personal display device 320A that can be displayed to the user. Similarly multiple personal display devices can request to display different portions of the area associated with the main display device. The personal display device 320A further performs a scaling function. Scaling allows the personal display device to be positioned accurately with respect to the corresponding main display device to which the personal display device is connected. Furthermore, scaling operation reduces the server load. The server, on receiving the request as discussed in the above paragraph from a plurality of personal display devices, consolidates the touch inputs arriving from multiple personal display devices and transmits the consolidated touch inputs to the electronic device 305 producing the main display video. The transmission can be performed directly or through communication standards, for example universal serial bus (USB) and the like.

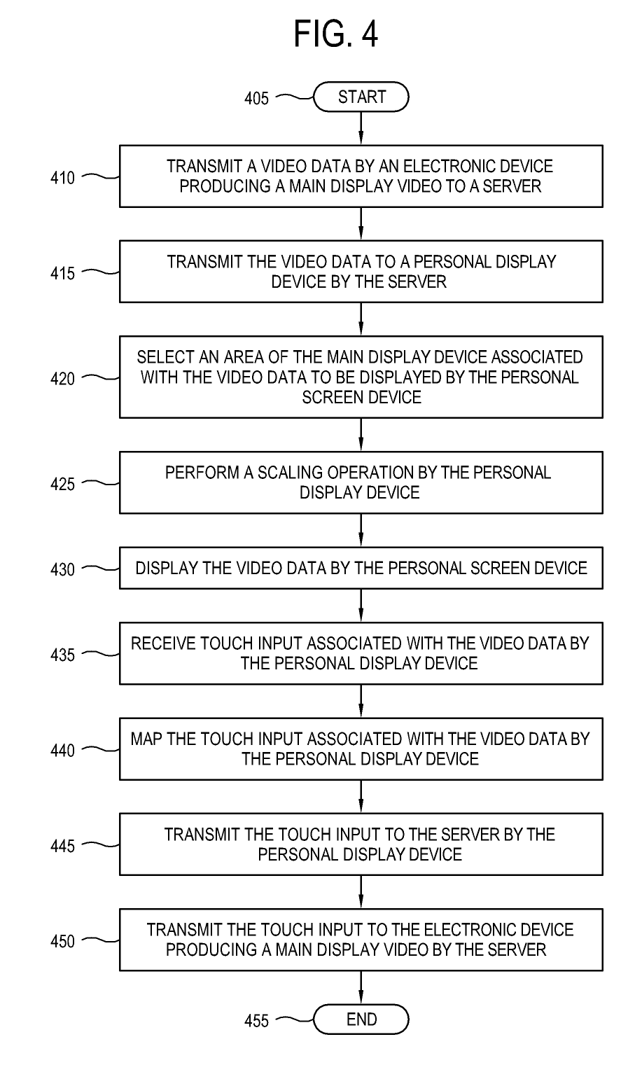

FIG. 4 is a flowchart illustrating a method for providing touch inputs to a display device in accordance with an exemplary embodiment.

The method starts at operation 405. At operation 410, a video data displayed on an electronic device 305 producing a main display video is transmitted to a server. The main display device can be embedded in an electronic device 305. Examples of electronic devices 305 include, but are not limited to, desktop, laptop, hand held computers, cell phones, personal digital assistant (PDA), smart phones, digital television (DTV), internet protocol television (IPTV), and play stations. The electronic device 305 producing the main display device can display a plurality of applications. Examples of applications include, but are not limited to, a plurality of games, video, audio, calculator, calendar and navigation. The application can be transmitted to the server either directly or through communication standards, for example universal serial bus (USB) and the like. Further, various communication channels can be used to transmit the application from the electronic device 305 producing the main display device to the server.

At operation 415 the video data received by the server from the electronic device 305 producing the main display video is transmitted to a personal display device. The video data from the server can be transmitted to the personal display device either directly or through the network as discussed in the above paragraph. The personal display device can be regarded as a small handy device that is capable of providing touch inputs to the application or the video data associated with the electronic device 305. The personal display device displays the video data thereby allowing a user to provide inputs to the video data associated with the electronic device 305 using the personal display device. Further, the personal display device acts as a communication medium between the user and the video data associated with the electronic device 305 and hence allowing the user to execute an application from a remote location.

At operation 420 an area of the main display video is chosen by the personal display device. The area chosen is displayed on the personal display device in order to impart touch inputs to the application or the video data by the user. Further, the area associated with the main display video corresponds to a particular application utilized by the user at a current period of time. The user can view the video data displayed on the personal display device and impart appropriate touch inputs to the video data. Furthermore, the user can access the video data associated with the electronic device 305 from the remote location using the personal display device. In one example, the electronic device 305 producing the main display video is associated with a plurality of applications. Examples of applications include, but are not limited to, a plurality of games, video, audio, calculator, calendar and navigation. In one example, the user chooses to display a portion of the main display device corresponding to the calculator application. Upon choosing the portion, the personal display device sends a request to the electronic device 305 producing the main display video through the server. Upon acknowledging the request, the calculator application that is associated with the electronic device 305 producing the main display video is displayed on the personal display device.

In an exemplary embodiment, the personal display device supports a scribbling function. The scribbling function allows the user to scribble on the personal display device. Further, the scribbling function can be performed in two modes. The two modes include a private mode and a public mode. The data scribbled on the private mode is displayed on the personal display device. Further, the data scribbled by the user in the public mode is displayed on the main display device. The scribbling function can be performed using passive devices, for example stylus and the like.

At operation 425 a scaling operation is performed by the personal display device. The scaling operation is performed so that the touch inputs provided by the user are with reference to the electronic device 305 producing the main display video. Further, the scaling operation allows accurate positioning of the application on the personal display device. Furthermore, the personal display device includes a selection panel and a pointing device. The selection panel and the pointing device aids in positioning the application displayed by the personal display device with respect to the area associated with the electronic device 305 producing the main display video. The positioning can be changed dynamically.

At operation 430 the personal display device displays the video data associated with the electronic device 305 producing the main display video. The personal display device is associated with a display unit. The display unit, in one example, liquid crystal display (LCD) is embedded in the personal display device. Examples of various other display units that can be embedded in the personal display device include, but are not limited to, plasma display, flat panel display, electroluminescent display and light emitting diode (LED) display. The display unit allows the display of the video data associated with the main display device. The user can view the video using the display unit embedded in the personal display device. Further upon subsequent viewing of the video displayed on the personal display device, the user can impart appropriate touch inputs to the video using the personal display device.

At operation 435 the user provides touch inputs to the video data associated with the application using the personal display device. The user employs the selection panel and the pointing device for providing touch inputs. The video data associated with the electronic device 305 producing the main display video is executed by imparting touch inputs to the video data. Touch inputs are provided by the personal display device to the video data through the server. The server transmits the touch inputs provided by the user using the personal display device to the electronic device 305 producing the main display video. Further, touch inputs provided by the user can be transmitted from the personal display device to the server through the network. Furthermore the server transmits the touch inputs provided by the user to the electronic device 305 producing the main display video through the physical layer. The server does not utilize the session layer to transmit touch inputs provided by the user to the electronic device 305 producing the main display video thereby avoiding transmission complexities.

At operation 440 the personal display device maps the touch inputs provided by the user with the video data. The mapping helps to provide appropriate touch inputs from the personal display device to the video data associated with the electronic device 305 producing the main display video. The server facilitates the mapping of touch inputs with the video data associated with the electronic device 305 producing the main display video. Mapping is performed using software installed in an operating system of the personal display device. Examples of operating systems include, but are not limited to, Mac OS, Windows, Ubuntu, Android, Nokia and N-touch platforms.

At operation 445 touch inputs provided by the user using the personal display device are transmitted to the server. The server acts as a communication medium between the user and the electronic device 305 producing the main display video. Further, the touch inputs from the personal display device are transmitted to the server through the network.

At operation 450 touch inputs are transmitted by the server to the electronic device 305 producing the main display video. The server transmits touch inputs to electronic device 305 producing the main display video directly or by using communication standards, for example, USB and the like. The main display device displays the video data on the personal display device in response to the touch inputs provided by the user. The method ends at operation 455.

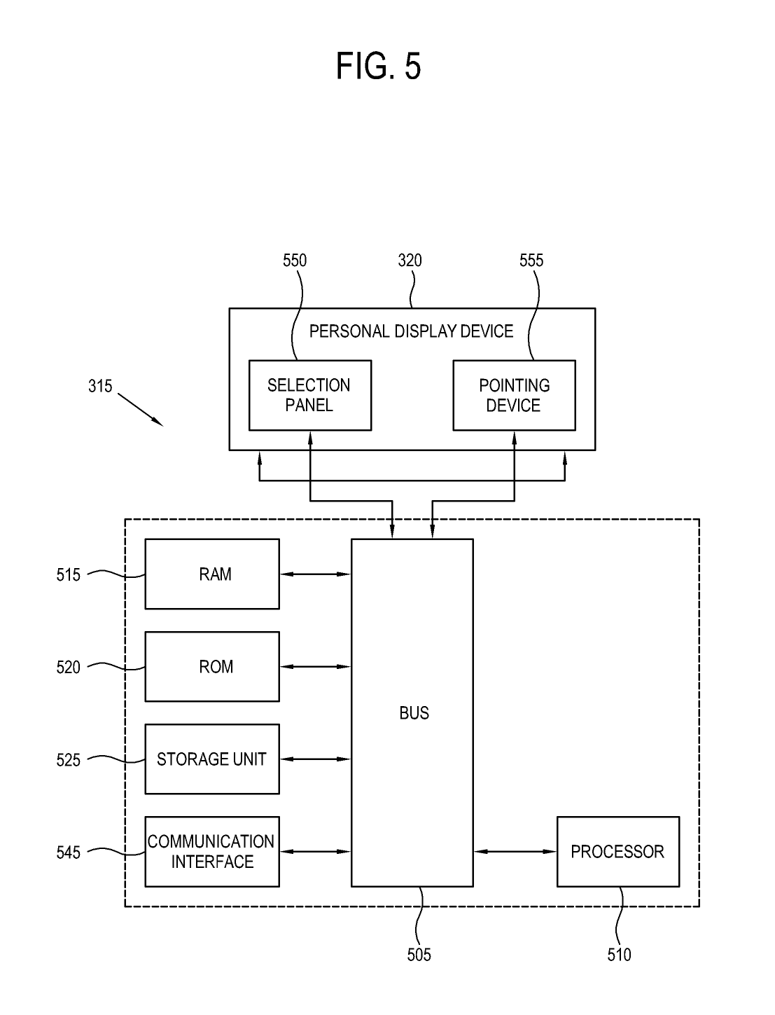

FIG. 5 is a block diagram of a server in accordance with an exemplary embodiment. The server 315 includes a bus 505 or other communication mechanism for communicating information, and a processor 510 coupled with the bus 505 for processing information. The server 315 also includes a memory 515, such as a random access memory (RAM) or other dynamic storage device, coupled to the bus 505 for storing information and instructions to be executed by the processor 510. The memory 515 can be used for storing temporary variables or other intermediate information during execution of instructions to be executed by the processor 510. The server 315 further includes a read only memory (ROM) 520 or other static storage device coupled to bus 505 for storing static information and instructions for processor 510. A storage unit 525, such as a magnetic disk or optical disk, is provided and coupled to the bus 505 for storing information, for example search logs and a plurality of queries.

The server 315 can be coupled via the bus 505 to a personal display device 320 for displaying an application to the user. The personal display device 315, including a selection panel 550 and a pointer device 555, in one example a track ball, is coupled to bus 505. The selection panel 550 and the pointer device 555 are used for providing touch inputs. The selection panel 550 and the pointing device 555 aid in positioning the application displayed by the personal display device with respect to the area associated with the electronic device 305 producing the main display video. The positioning can be changed dynamically.

Various exemplary embodiments are related to the use of server 315 for implementing the techniques described herein. In some embodiments, the techniques are performed by the server 315 in response to the processor 510 executing instructions included in the memory 515. Such instructions can be read into the memory 515 from another machine-readable medium, such as the storage unit 525.

In some exemplary embodiments, the processor 510 can include one or more processing units for performing one or more functions of the processor 510. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 315, various machine-readable media are involved, for example, in providing instructions to the processor 510 for execution. The machine-readable medium can be a storage medium, either volatile or non-volatile. A volatile medium includes, for example, dynamic memory, such as the memory 515. A non-volatile medium includes, for example, optical or magnetic disks, such as storage unit 525. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punch cards, papertape, any other physical media with patterns of holes, a RAM, a PROM, and EPROM, a FLASH-EPROM, any other memory chip or cartridge.

In another exemplary embodiment, the machine-readable media can be transmission media including coaxial cables, copper wire and fiber optics, including the wires that comprise the bus 505. Transmission media can also take the form of acoustic or light waves, such as those generated during radio-wave and infra-red data communications. Examples of machine-readable media may include, but are not limited to, a carrier wave as described hereinafter or any other media from which the server 505 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 505 can receive the data on the telephone line and use an infra-red transmitter to convert the data to an infra-red signal. An infra-red detector can receive the data carried in the infra-red signal and appropriate circuitry can place the data on the bus 505. The bus 505 carries the data to the memory 515, from which the processor 510 retrieves and executes the instructions. The instructions received by the memory 515 can optionally be stored on storage unit 525 either before or after execution by the processor 510. All such media must be tangible to enable the instructions carried by the media to be detected by a physical mechanism that reads the instructions into a machine.

The server 315 also includes a communication interface 545 coupled to the bus 505. The communication interface 545 provides a two-way data communication. The communication between the server and an electronic device 305 acquiring the main display device can be achieved either directly or through communication standards, for example universal serial bus (USB) and the like.

The server is responsible for receiving touch inputs provided by a user. Further the server also transmits the application to the user in response to touch inputs provided by the user.

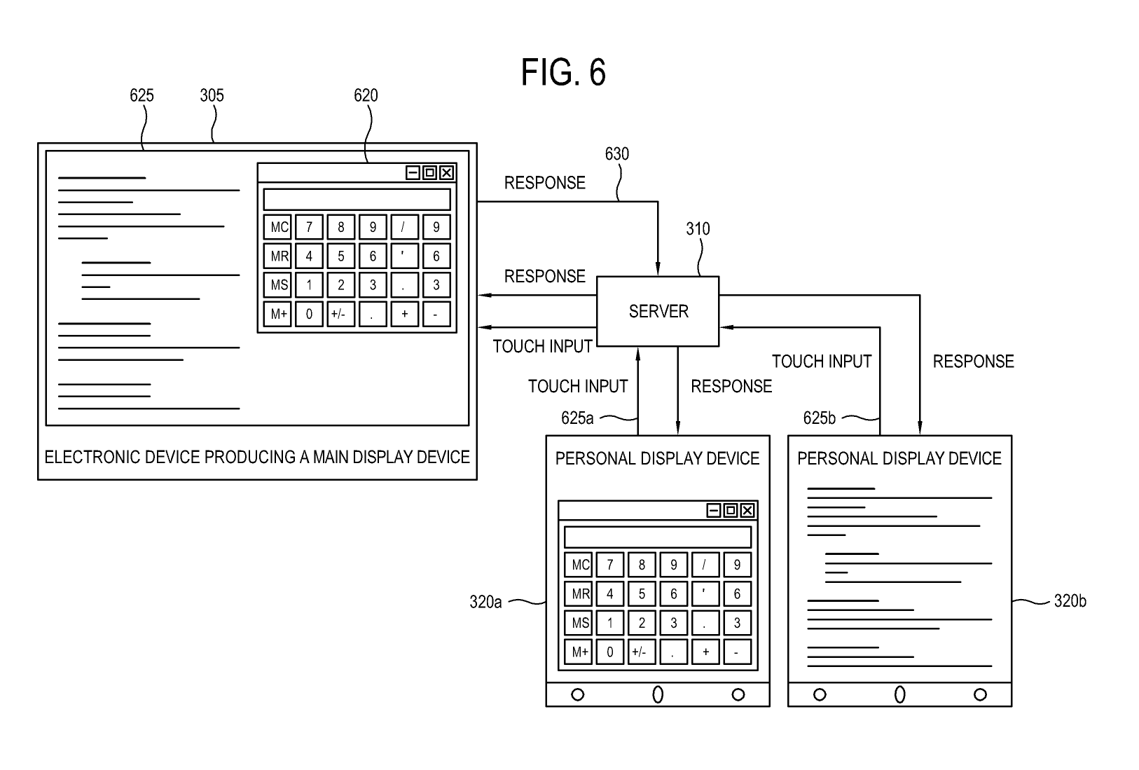

FIG. 6 is an exemplary illustration associated with a first application for providing touch inputs in accordance with an exemplary embodiment. FIG. 6 includes an electronic device 305 producing a main display video, a server 310, personal display devices 320A and 320B, the first application 620, and an information content 625.

The electronic device 305 producing the main display video displays the first application 620 and the information content 625 browsed using the internet. The first application 620 in the present example is a calculator application. A user of the personal display device 320A desires to utilize the calculator application. Further, the user of the personal display device 320B desires to view the information content. Hence the user of the personal display device 320A sends a request to the server 310 for displaying the calculator application. Further the user of the personal display device 320B sends a request to the server 310 to view the information content on the personal display device 320B. The server communicates the request sent by the users of the personal display devices 320A and 320B respectively to the electronic device 305 producing the main display video. The electronic device 305 producing the main display video, in response to the request transmits the video associated with the calculator application to the user of the personal display device 320A through the server. Further, the electronic device 305 producing the main display video in response to the user of the personal display device 320B transmits the information content browsed using internet to be displayed on the personal display device 320B.

On receipt of the calculator application sent by the electronic device 305 producing the main display video, the personal display device 320A displays the calculator application. Each of the personal display devices 320A and 320B are associated with a display unit that facilitates the user to view the first application transmitted by the electronic device 305 producing the main display video. Examples of display unit includes, but are not limited to, electronic visual display, electronic ink display, Liquid crystal display (LCD), cathode ray tube (CRT), light emitting diode (LED) display, plasma display and electroluminescent display. Upon viewing, the user can execute the calculator application. Execution of the calculator application can be performed by providing a touch input. The touch input can be provided by the user using the personal display device 320A. The personal display device is associated with a selection panel and a pointer device for providing the touch input. The user can select an area associated with the calculator application on the electronic device 305 producing the main display video using the selection panel and the pointer device. Further, the selection panel and the pointer device facilitates accurate positioning of the first application with reference to the main display device. The user provides the touch input 625 to the server 310. Further, the server transmits the touch input 625 to the electronic device 305 producing the main display video. The electronic device 305, upon receiving the touch input associated with the calculator application responds to the touch input as shown in 630. The calculator application is executed in response to the touch input provided by the user using the personal display device. One personal display device can execute the calculator application while the other personal display device can display a webpage, associated with the main display video simultaneously. Further, the personal display device can be located at a remote position. The user of the personal display device can execute the calculator application from the remote position by providing touch inputs that are transmitted to the electronic device 305 producing the main display video through the server.

On receipt of the information content sent by the main display device, the personal display device 320B displays the information content. The user can view the information content and can take further action steps as desired by the user.

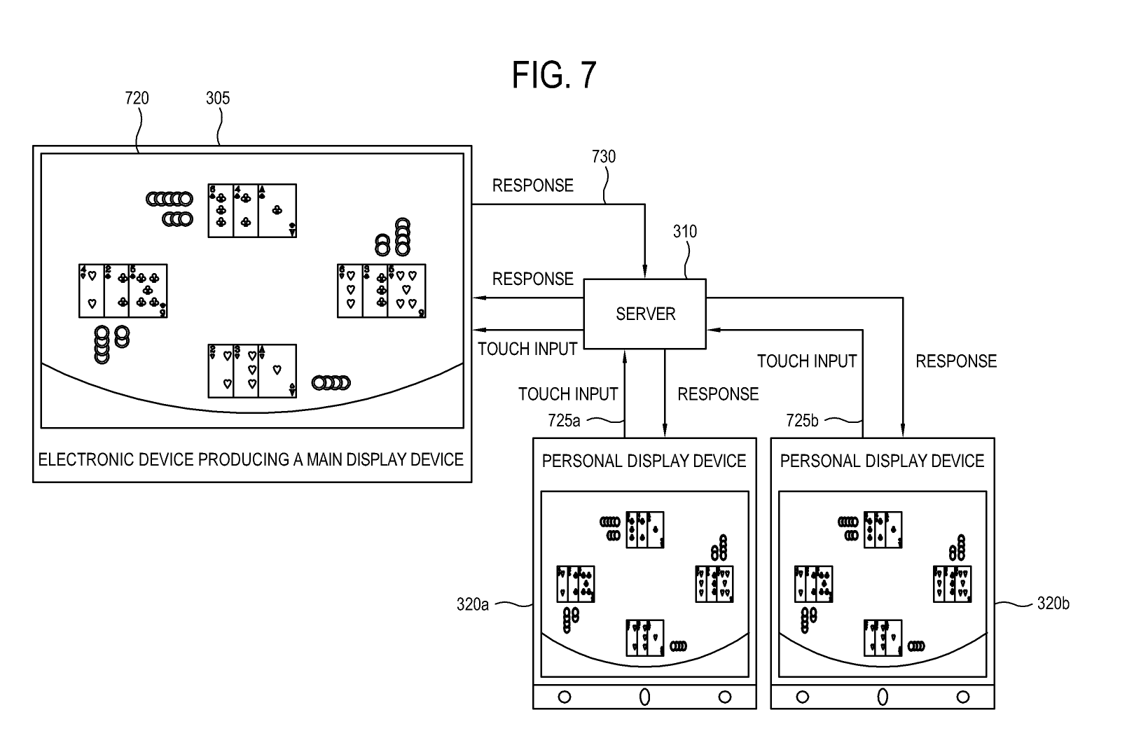

FIG. 7 is an exemplary illustration associated with a second application for providing touch inputs in accordance with an exemplary embodiment. FIG. 7 includes an electronic device 305 producing a main display video, a server 310, personal display devices 320A and 320B and the second application 720.

The electronic device 305 producing the main display video displays the second application 720. The second application 720 in the present example is a card-game application. Users of the personal display devices 320A and 320B desire to play the card-game application. Hence the users of the personal display devices 320A and 320B transmit requests to the server 310 using the personal display devices 320A and 320B respectively for displaying the card-game application. The server communicates the requests sent by the users of the personal display devices 320A and 320B to the electronic device 305 producing the main display video. In response to the requests, the electronic device 305 producing the main display video transmits the card-game application to the users of the personal display devices 320A and 320B through the server.

On receipt of the card-game application sent by the main display device, the personal display devices 320A and 320B display the card-game. The personal display devices 320A and 320B are associated with a display unit that facilitates the user to view the card-game transmitted by the electronic device 305 producing the main display video. Examples of a display unit include, but are not limited to, an electronic visual display, an electronic ink display, a Liquid crystal display (LCD), a cathode ray tube (CRT), a light emitting diode (LED) display, a plasma display and an electroluminescent display. Upon viewing, the users of the personal display devices 320A and 320B can play the card-game. The users can play the card-game by providing touch inputs as shown in 725A and 725B.

The touch inputs can be provided by the users of the personal display devices 320A and 320B. A touch input includes, in one example, information regarding a particular card to be moved to a particular location. Further, in another example, the users can drag the cards by viewing their respective personal display devices. The moment caused due to dragging can be made visible in the main display device. Each of the personal display devices 320A and 320B are associated with a selection panel and a pointer device for providing the touch inputs. The users can select an area associated with the card-game application on the main display video using the selection panel and the pointer device. Further, the selection panel and the pointer device facilitates for accurate positioning of the card-game with reference to the main display video. The users can provide the touch inputs as shown in 725A and 725B to the server 310. The server 310 transmits the touch inputs to the electronic device 305 producing the main display video. The electronic device 305 producing the main display video, upon receiving the touch inputs associated with the card-game application responds to the touch inputs as shown in 730. The card-game can be played on the personal display devices in response to the touch input provided by the users. Similarly one or more users using one or more personal display devices can play the card-game associated with the electronic device 305 producing the main display video simultaneously. Further, the personal display device can be located at a remote position. The user of the personal display device can play the card-game from the remote position by providing touch inputs that are transmitted to the electronic device 305 producing the main display video through the server.

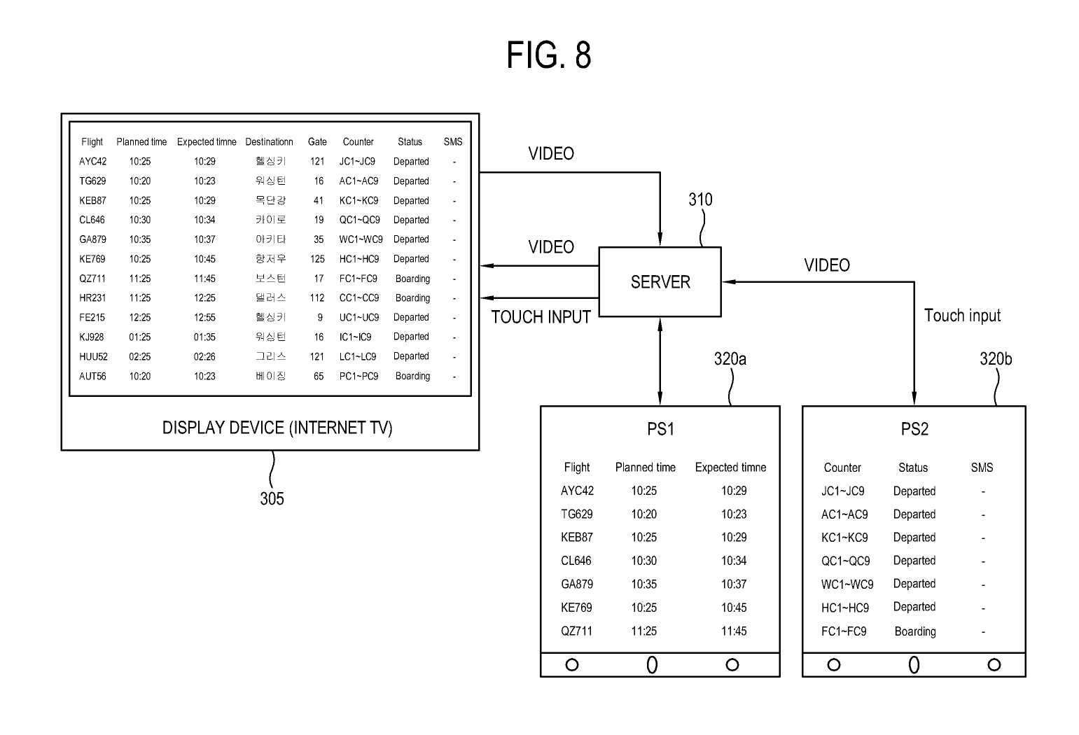

FIG. 8 is an exemplary illustration for viewing contents displayed on an electronic device 305 producing a main display video on multiple personal display devices in accordance with an exemplary embodiment. FIG.8 includes the electronic device 305 producing the main display video, a server 310 and personal display devices 320A and 320B.

The electronic device 305 producing the main display video displays a list of multiple flights arriving and departing from an airport. Further the arrival time and departure time of the flights are displayed on the electronic device 305 producing the main display video. A user of the personal display device 320A can view the list displayed on the electronic device 305 producing the main display video on the personal display device 320A of the user. Further, another user using personal display device 320B can view the list that are displayed on the electronic device 305 producing the main display video on the personal display device 320B. Similarly multiple users possessing their own personal display devices can view the list of flights displayed on the electronic device 305 producing the main display video. Each of the personal display devices 320A and 320B are associated with a selection panel and a pointer device for selecting a portion of an area associated with the main display device. Further, the selected portion can be displayed on their respective personal display devices for viewing. Furthermore, the users can provide touch inputs using the personal display devices to acquire detailed information regarding the list displayed. The touch inputs provided by the user are transmitted to the electronic device 305 producing the main display video through a server 310. The server 310 is responsible for transmitting the touch inputs provided by multiple users to the electronic device 305 producing the main display video.

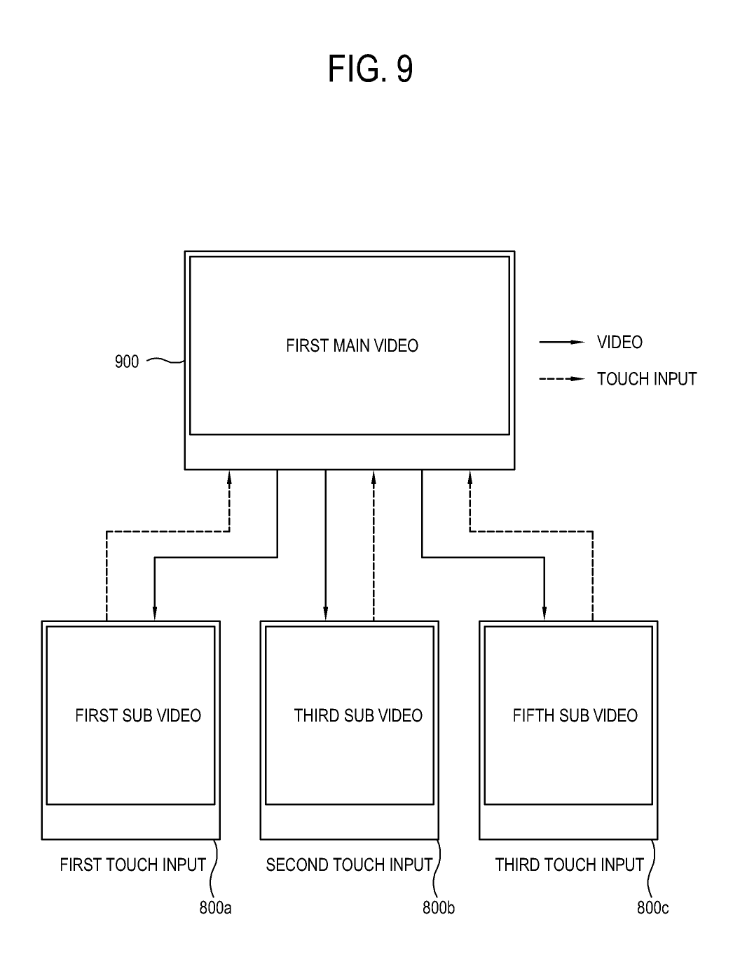

FIG. 9 is a schematic view of a system for providing touch inputs according to another exemplary embodiment. In this exemplary embodiment, a display device 900, which performs a function similar to that of the electronic device 305, produces and displays a main display video. Therefore, the display device 900 may be used as an example of the electronic device 305 described in FIG. 3. In this exemplary embodiment, touch input providers 800a, 800b and 800c, which perform functions similar to those of the personal display devices described in FIG. 3, provide touch inputs from a users to the display device 900. However, the system in this exemplary embodiment is different from that of FIG. 3 in that the touch input providers 800a, 800b and 800c can directly perform wired/wireless communications with the display device 900 and transmit and receive various data and/or control signals. Thus, the touch input providers 800a, 800b and 800c and the display device 900 may use Wi-Fi, Bluetooth, ZigBee or the like for the wireless communication.

Referring to FIG. 9, the display device 900 produces and displays first main video. As requested by the touch input providers 800a, 800b and 800c, first main video is transmitted to the touch input providers 800a, 800b and 800c and displayed.

At this time, each of the touch input providers 800a, 800b and 800c receives a user's input that selects at least one area of first main video through a user input unit, and displays an area corresponding to the user's input. For example, a first touch input provider 800a may display a first sub video based on the user's input with regard to the first main video, a second touch-input provider 800b may display a third sub video based on the user's input with regard to the first main video, and a third touch-input provider 800c may display a fifth sub video based on the user's input with regard to the first main video. Here, the first to third sub videos may be the same with or different from each other.

The first touch input provider 800a transmits user's touch input to the display device 900 if receiving the user's touch input with regard to the first sub video, and displays a second sub video corresponding to the position of the first sub video in a second main video corresponding to the user's touch input.

The second touch input provider 800b transmits user's touch input to the display device 900 if receiving the user's touch input with regard to the third sub video 800b, and displays a fourth sub video corresponding to the position of the third sub video in a third main video corresponding to the user's touch input.

The third touch-input provider 800C transmits user's touch input to the display device 900 if receiving the user's touch input with regard to the fifth sub video, and displays a sixth sub video corresponding to the position of the fifth sub video in a fourth main video corresponding to the user's touch input.

According to this system for providing touch inputs, the touch input providers 800a, 800b and 800c are used for providing a user's touch input to the display device 900 that cannot receive the user's touch input. Further, the wireless communication between the display device 900 and the touch input providers 800a, 800b and 800c is enabled, so that the touch input providers 800a, 800b and 800c can provide user's touch inputs to the display device 900 even though they are remote from the display device 900. Also, the plurality of touch input providers 800a, 800b and 800c may provide a plurality of user's touch inputs to one display device 900.

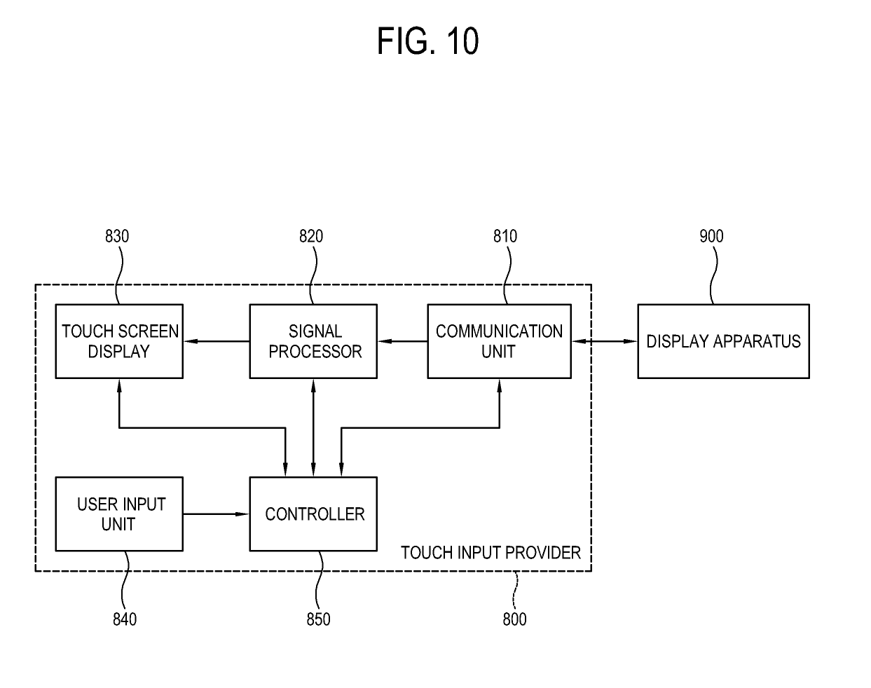

FIG. 10 is a control block diagram of the touch input provider included in the touch input providing system of FIG. 9.

As shown in FIG. 10, the touch input provider 800 includes a communication unit 810, a signal processor 820, a touch screen display 830, a user input unit 840, and a controller 850 controlling them.

The communication unit 810 can communicate with the display device 900 and carry out wired/wireless communication, for example, using WLAN, Wi-Fi, Bluetooth, ZigBee, etc. Under control of the controller 850 to be described later, the communication unit 810 may request first main video being currently displayed on the display device 900 and receive the first main video from the display device 900. Further, the communication unit 810 transmits user's touch inputs through the touch screen display to be described later to the display device 900, and receives second main video corresponding to the user's touch inputs.

The signal processor 820 processes the first main video or the second main video received through the communication unit 810 under the control of the controller 850 so that the first main video or the second main video can be displayed on the touch screen display 830. The signal processor 820 applies a scaling process to the first main video or the second main video to be displayed on the touch screen display 830. If at least one area of first main video is selected through the user input unit 840, the signal processor 820 performs the scaling process so that first sub video corresponding to the selected area can be displayed on the touch screen display 830. Also, if receiving the second main video through the communication unit 810, the signal processor 820 performs the scaling process so that second sub video corresponding to the location of first sub video can be displayed on the touch screen display 830. Besides the scaling process, the signal processor 820 may perform processes such as decoding and encoding corresponding to various video formats, deinterlacing, frame refresh rate conversion, noise reduction for improving video quality, detail enhancement, line scanning, etc.

The touch screen display 830 may receive a user's touch inputs and display a predetermined video. The touch screen display 830 may be a resistive type or a capacitive type to receive touch inputs from a user, using a user's finger or a stylus pen, a pointing device (not shown), etc. Further, the touch screen display 830 receives and displays a video signal processed by the signal processor 820.

The user input unit 840 may receive a user input for selecting first sub video corresponding to at least one area of first main video displayed on the touch screen display 830. The user input unit 840 is a user interface capable of receiving a user's selection, which can receive a user's selection related to the function or operation of the touch input provider 800. The user input unit 840 may be provided with at least one key button as a hot key. The user input unit 610 may include a plurality of physical function keys, for example, minimal buttons such as a power on/off key, arrow keys, a trackball, etc.

The controller 850 controls the elements of the foregoing touch input provider 800, which controls the touch screen display 830 to display first sub video corresponding at least one area of first main video being currently displayed on the display device 900, and controls the communication unit 820 to receive second sub video corresponding to the position of first sub video in third main video corresponding to the first user touch input from the display device.

If receiving a certain key input from the user input unit 840, the controller 850 controls the communication unit 810 to receive first main video being currently displayed from the display device 900. For example, the certain key input may be a power-on key of the touch input provider 800.

The controller 850 may receive a user input of selecting first sub video corresponding to at least one area of first main video through the user input unit 840. The first sub video may be a part or the while of the first main video.

If receiving a first user touch input for the first sub video through the touch screen display 830, the controller 850 may convert the first user touch input into a second user touch input for the first main video and control the communication unit 810 to transmit the second user touch input to the display device 900. Here, the controller 850 converts the first user touch input into the second user touch input having a position corresponding to the first user touch input in the first main video on the basis of position information of the first user touch input for the first sub video, and transmits it to the display device 900.

The controller 850 receives the second main video converted corresponding to the second user touch input in the first main video from the display device 900, and controls the signal processor 820 to process second sub video of the second main video corresponding the position of the first sub video and display it on the touch screen display 830.

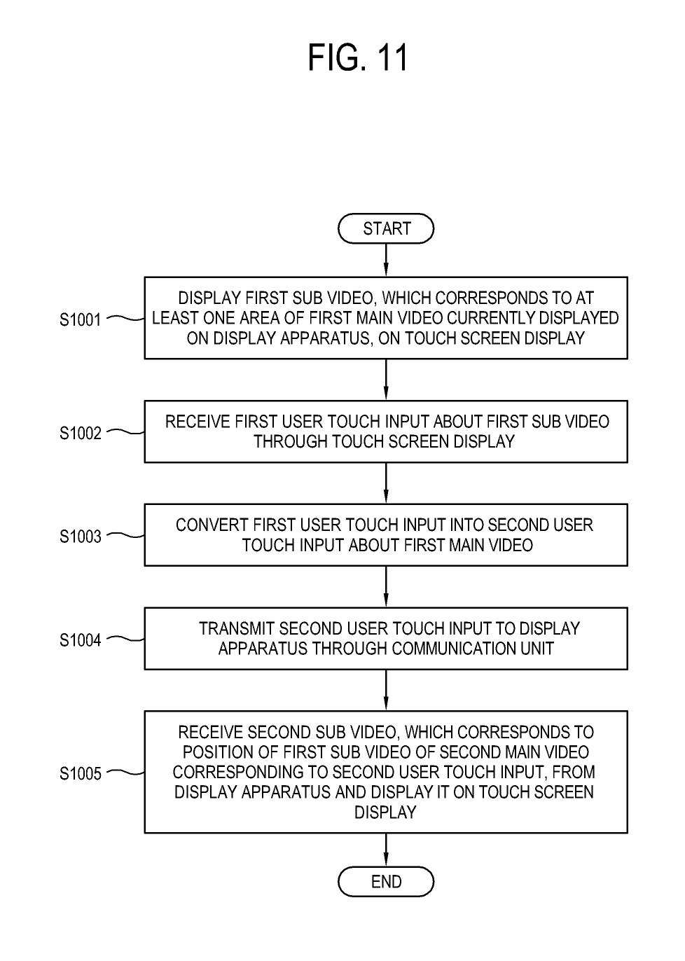

FIG. 11 is a flowchart of a control operation in the touch input provider of FIG. 10.

As shown in FIG. 11, at operation S1001, the touch input provider 800 receives first main video being currently displayed in the display device 900 from the display device 900 if a certain key input is received through the user input unit 840, and displays first sub video corresponding to at least one area of first main video on the touch screen display 830 in accordance with a user's selection input received through the user input unit 840.

The touch input provider 800 receives first user touch input about first sub video through touch screen display 830 at operation S1002, converts the first user touch input into second user touch input about first main video at operation S1003, and transmits the second user touch input to the display device 900 at operation S1004. At operation S1005, the touch input provider 800 receives second main video, which converted corresponding to second user touch input from first main video, from the display device 900, and displays second sub video corresponding to the position of the first sub video of the second main video on the touch screen display 830.

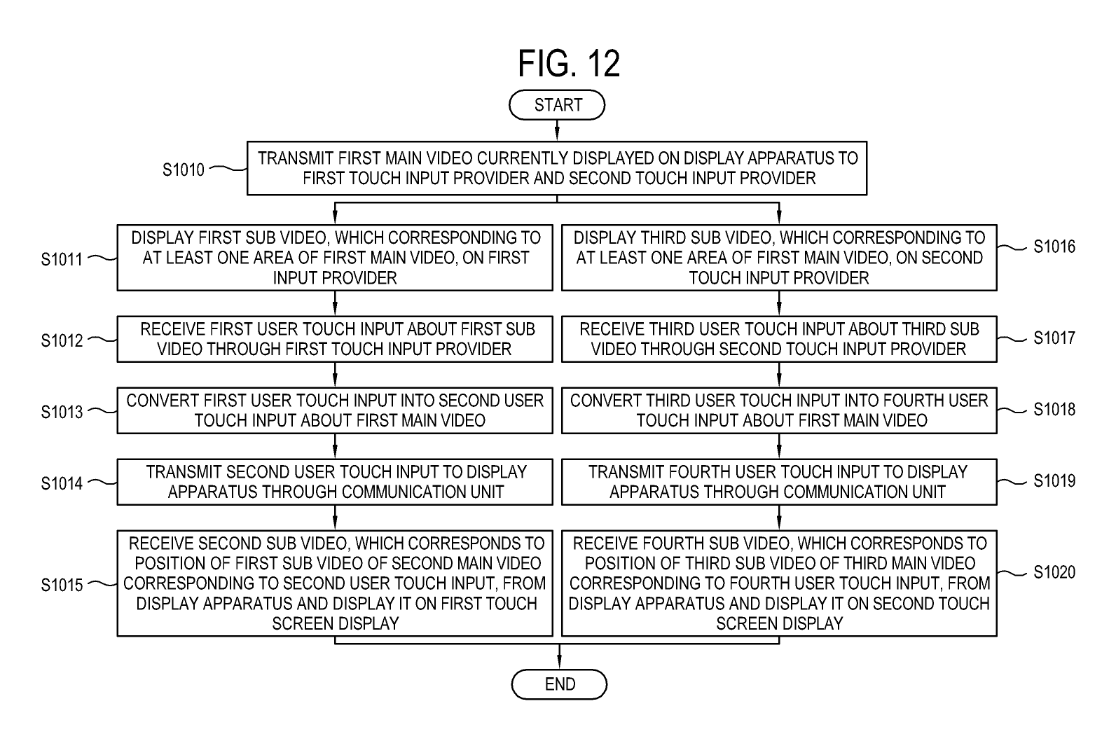

FIG. 12 is a flowchart of the system for providing touch inputs in FIG. 9.

As shown in FIG. 12, at operation S1010, each of the first touch input provider 800a and the second touch input provider 800b receives first main video being currently displayed from the display device 900 and displays it on the touch screen display if a certain key input is received through the user input unit.

The first touch input provider 800a displays first sub video, which corresponds to at least one area of first main video, at operation S1011, receives the first user touch input about the first sub video at operation S1012, converts the first user touch input into a second user touch input about the first main video at operation S1013, transmits the second user touch input to the display device 900 at operation S1014, and receives second main video converted corresponding to the second user touch input in the first main video from the display device 900, and displays the second sub video corresponding to the position of the first sub video in the second main video at operation S1015.

Like the first touch input provider 800a, the second touch input provider 800b displays third sub video, which corresponds to at least one area of the first main video, at operation S1016, receives a third user touch input about third sub video at operation S1017, converts the third user touch input into a fourth user touch input about the first main video at operation S1018, transmits the fourth user touch input to the display device 900 at operation S1019, and receives third main video converted corresponding to the fourth user touch input in the first main video from the display device 900 and displays the fourth sub video, which corresponds to the position of the third sub video of the third main video at operation S1020.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. An apparatus for providing touch inputs to a display device, the apparatus comprising:
a touch screen display which receives a touch input from a user;
a communication unit which communicates with the display device; and
a controller which controls the touch screen display to display a first sub video corresponding to at least one area of first main video being displayed on the display device, controls the touch screen display to receive a first user touch input about the first sub video, and controls the communication unit to receive, from the display device, a second sub video corresponding to a position of the first sub video in a second main video being displayed on the display device corresponding to the first user touch input.

2. The apparatus according to claim 1, wherein the controller converts the first user touch input about the first sub video into a second user touch input about the first main video and controls the communication unit to transmit the second user touch input to the display device.

3. The apparatus according to claim 1, further comprising a user input unit which receives a user input for selecting the first sub video in the first main video.

4. The apparatus according to claim 1, further comprising a signal processor which processes the first sub video and the second sub video to be displayed on the touch screen display.

5. A system for providing touch inputs, the system comprising:
a display device; and
a touch input provider comprising:
a touch screen display which receives a touch input from a user,
a communication unit which communicates with the display device, and
a controller which controls the touch screen display to display a first sub video corresponding to at least one area of first main video being displayed on the display device, controls the touch screen display to receive a first user touch input about the first sub video, and controls the communication unit to receive, from the display device, a second sub video corresponding to a position of the first sub video in a second main video corresponding to the first user touch input.

6. The system according to claim 5, wherein the controller converts the first user touch input about the first sub video into a second user touch input about the first main video and controls the communication unit to transmit the second user touch input to the display device.

7. The system according to claim 5, further comprising a user input unit which receives a user input for selecting the first sub video in the first main video.

8. The system according to claim 5, further comprising a signal processor which processes the first sub video and the second sub video to be displayed on the touch screen display.

9. The system according to claim 5, wherein the touch input provider is a first touch input provider, and the system further comprises:
a second touch input provider, the second touch input provider comprising:
a second touch screen which receives a touch input from a user,
a second communication unit which communicates with the display device, and
a second controller which controls the second touch screen display to display a third sub video corresponding to at least one area of the first main video, controls the second touch screen display to receive a third user touch input about the third sub video, and controls the second communication unit to receive, from the display device, a fourth sub video corresponding to a position of the third sub video in a third main video corresponding to the third user touch input.

10. The system according to claim 9, wherein the first sub video and the third sub video are different from each other.

11. A method of providing touch inputs in a touch input provider which provides touch inputs to a display device, the method comprising:
displaying first sub video on a touch screen display of the touch input provider, wherein the first sub video corresponds to at least one area of first main video being displayed on the display device;
receiving a first user touch input about the first sub video through the touch screen display;
transmitting the first user touch input to the display device through a communication unit; and
receiving a second sub video corresponding to a position of the first sub video in a second main video being displayed on the display device, the second sub video corresponding to the first user touch input from the display device and displaying the second sub video on the touch screen display.

12. The method according to claim 11, wherein the transmitting the first user touch input comprises
converting the first user touch input about the first sub video into a second user touch input about the first main video and transmitting the second user touch input to the display device.

13. The method according to claim 11, further comprising selecting the first sub video in the first main video through a user input unit.

14. The method according to claim 11, further comprising processing the first sub video and the second sub video to be displayed on the touch screen display.

15. A method of providing touch inputs in a touch input provider of a system comprising a display device, the method comprising:
displaying a first sub video on a touch screen display of the touch input provider, wherein the first sub video corresponds to at least one area of first main video being currently displayed on the display device;
receiving a first user touch input about the first sub video, in the touch input provider;
transmitting the first user touch input from the touch input provider to the display device; and
receiving, from the display device, a second sub video corresponding to a position of the first sub video in a second main video being displayed on the display device, the second sub video corresponding to the first user touch input and displaying the second sub video in the touch input provider.

16. The method according to claim 15, wherein the transmitting the first user touch input comprises
converting the first user touch input about the first sub video into a second user touch input about the first main video and transmitting the second user touch input to the display device.

17. The method according to claim 15, further comprising selecting the first sub video in the first main video through the touch input provider.

18. The method according to claim 15, further comprising processing the first sub video and the second sub video to be displayed in the touch input provider.

19. The method according to claim 15, wherein the touch input provider is a first touch input provider, the method further comprising:
displaying a third sub video on a second touch input provider, wherein the third sub video corresponds to at least one area in the first main video;
receiving a third user touch input about the third sub video in the second touch input provider; and
receiving a fourth sub video corresponding to a position of the third sub video in a third main video, the fourth sub video corresponding to the third user touch input from the display device and displaying the fourth sub video in the second touch input provider.

20. The method according to claim 19, wherein the first sub video and the third sub video are different from each other.

21. A system for providing touch inputs comprising:
a display device;
a plurality of touch input providers, each touch input provider comprising:
a touch screen display which receives a touch input from a user,
a communication unit which communicates with the display device, and
a controller which controls the touch screen display to display at least a portion of a main video being displayed on the display device, controls the touch screen display to receive a touch input from a user, controls the communication unit to transmit information regarding the touch input to the display device and to receive information from the display device regarding a sub-video corresponding to the touch input, and controls the touch screen display to display the sub-video.
